(19) United States
(12) Patent Application Publication
(10) Pub. No.: US 2025/0243350 A1
(43) Pub. Date: Jul. 31, 2025

(54) RUBBER COMPOSITION AND PNEUMATIC TIRE

(71) Applicant: Toyo Tire Corporation, Itami-shi (JP)

(72) Inventor: Hironori Miyazaki, Itami-shi (JP)

(73) Assignee: Toyo Tire Corporation, Itami-shi (JP)

(21) Appl. No.: 19/007,795

(22) Filed: Jan. 2, 2025

(30) Foreign Application Priority Data
Jan. 25, 2024 (JP) 2024-009275

(51) Int. Cl. C08L 9/06; B60C 1/00; C08K 3/06; C08K 5/17; C08K 5/3417; C08K 5/3437; C08L 7/00

(52) U.S. Cl. CPC C08L 9/06; B60C 1/00; C08K 3/06; C08K 5/17; C08K 5/3417; C08K 5/3437; C08L 7/00; C08L 2205/025; C08L 2312/02

(57) ABSTRACT

A rubber composition containing a diene-based rubber, sulfur, and a nitrogen atom-containing alkaloid compound having a melting point of 200° C. or lower. It is preferred that the nitrogen atom-containing alkaloid compound has a tertiary amine structure. It is preferred that a mass ratio (A/B) between a content A of the nitrogen atom-containing alkaloid compound and a content B of the sulfur in the rubber composition is 0.2 to 2.0. It is preferred that the nitrogen atom-containing alkaloid compound is at least one selected from the group consisting of gramine, pseudopelletierine, hordenine, and tetrahydropalmatine.

### BACKGROUND OF THE INVENTION

### Field of the Invention

The present invention relates to a rubber composition and a pneumatic tire.

### Description of the Related Art

In recent years, companies have been required to address SDGs, which means Sustainable Development Goals, irrespective of the intended uses of pneumatic tires and the like. SDGs consists of 17 goals, and SDGs12-2 (By 2030, achieve the sustainable management and efficient use of natural resources) is one of them.

Patent Document 1 mentioned below discloses a method for producing an antiaging agent, the method comprising the steps of: microbially converting glucose to benzoic acid or a benzoic acid derivative or extracting benzoic acid or a benzoic acid derivative from a plant; and converting the obtained benzoic acid or benzoic acid derivative to aniline or an aniline derivative.

Patent Document 2 mentioned below discloses a method for producing an antiaging agent, the method comprising the steps of: hydrolyzing indigo extracted from a plant to obtain 2-aminobenzoic acid; decarboxylating the obtained 2-aminobenzoic acid to obtain aniline; and synthesizing an amine-based antiaging agent or a benzimidazole-based antiaging agent from the obtained aniline.

Patent Document 3 mentioned below discloses a vulcanization accelerator synthesized from biological resources including plant resources, the vulcanization accelerator having a Δ14C value of −75% to −225%.

### PRIOR ART DOCUMENT

### Patent Documents

Patent Document 1: JP-A-2011-83288
Patent Document 2: JP-A-2016-222575
Patent Document 3: JP-A-2014-34598

### SUMMARY OF THE INVENTION

As described above with reference to the techniques disclosed in Patent Documents 1 to 3, there are techniques for blending a natural product into a rubber composition. However, there is little technique intended to significantly improve the physical properties of a vulcanized rubber to be finally obtained from a rubber composition. In addition, as far as the present inventor is aware, there is no report about a technique using a natural product in consideration of interaction with sulfur in a vulcanization step.

In light of such circumstances, it is an object of the present invention to provide a rubber composition using a natural product as a compounding agent alternative to a vulcanization accelerator, the rubber composition showing excellent vulcanization characteristics (maximum torque) and being capable of producing a vulcanized rubber excellent in rubber properties such as tensile strength at break, and a pneumatic tire including at least a vulcanized rubber of the rubber composition.

The above object can be achieved by the following configurations. Specifically, the present invention relates to a rubber composition (1) containing a diene-based rubber, sulfur, and a nitrogen atom-containing alkaloid compound having a melting point of 200° C. or lower.

The rubber composition (1) is preferably a rubber composition (2) in which the nitrogen atom-containing alkaloid compound has a tertiary amine structure.

The rubber composition (1) or (2) is preferably a rubber composition (3) in which a mass ratio (A/B) between a content A of the nitrogen atom-containing alkaloid compound and a content B of the sulfur in the rubber composition is 0.2 to 2.0.

Any one of the rubber compositions (1) to (3) is preferably a rubber composition (4) in which the nitrogen atom-containing alkaloid compound is at least one selected from the group consisting of gramine, pseudopelletierine, hordenine, and tetrahydropalmatine.

The present invention also relates to a pneumatic tire (5) including at least a vulcanized rubber of any one of the rubber compositions (1) to (4).

The rubber composition according to the present invention contains, in addition to a diene-based rubber, sulfur and a nitrogen atom-containing alkaloid compound having a melting point of 200° C. or lower. When sulfur and a nitrogen atom-containing alkaloid compound are present at the same time, a nitrogen atom in the alkaloid compound nucleophilically attacks a sulfur chain in a cross-linking reaction so that the sulfur chain is cleaved. When having a melting point of 200° C. or lower, the nitrogen atom-containing alkaloid compound is quickly melted in the diene-based rubber during vulcanization and is therefore excellent in dispersibility in the diene-based rubber. As a result of these, cross-linking of sulfur evenly proceeds in the diene-based rubber, which makes it possible to improve, for example, the vulcanization characteristics (maximum torque) of the rubber composition and the rubber properties, such as tensile strength at break, of a vulcanized rubber of the rubber composition. When having a tertiary amine structure, the nitrogen atom-containing alkaloid compound is excellent in dispersibility in the hydrophobic diene-based rubber because the tertiary amine structure does not contain a hydrogen bond and has high hydrophobicity. This makes it possible to further improve the vulcanization characteristics (maximum torque) of the rubber composition and the rubber properties, such as tensile strength at break, of a vulcanized rubber of the rubber composition. Particularly, when the nitrogen atom-containing alkaloid compound is at least one selected from the group consisting of gramine, pseudopelletierine, hordenine, and tetrahydropalmatine, the vulcanization characteristics of the rubber composition and the rubber properties of a vulcanized rubber of the rubber composition can particularly be improved because these alkaloid compounds have lower melting points than other alkaloid compounds and are therefore particularly excellent in dispersibility in the diene-based rubber during vulcanization.

As described above, in the case of the rubber composition according to the present invention, the nitrogen atom-containing alkaloid compound contributes to improved dispersibility while enhancing the cross-linkability of a sulfur chain. Particularly, setting a mass ratio (A/B) between a content A of the nitrogen atom-containing alkaloid compound and a content B of the sulfur in the rubber composition to 0.2 to 2.0 is preferred because the vulcanization characteristics of the rubber composition and the rubber properties of a vulcanized rubber of the rubber composition can particularly be improved.

A vulcanized rubber of the rubber composition according to the present invention has improved rubber properties such as maximum torque and tensile strength at break. Therefore, a vulcanized rubber of the rubber composition according to the present invention is particularly useful for pneumatic tires.

### DETAILED DESCRIPTION OF THE PREFERRED EMBODIMENTS

A rubber composition according to the present invention contains a diene-based rubber, sulfur, and a nitrogen atom-containing alkaloid compound.

Examples of the diene-based rubber include, but are not limited to, natural rubber (NR), isoprene rubber (IR), butadiene rubber (BR), styrene-butadiene rubber (SBR), acrylonitrile-butadiene rubber (NBR), chloroprene rubber (CR), styrene-isoprene copolymer rubber, a butadiene-isoprene copolymer, and styrene-isoprene-butadiene copolymer rubber. These diene-based rubbers may be used singly or in combination of two or more of them.

The sulfur may be ordinary sulfur for rubber, and sulfur such as powdered sulfur, precipitated sulfur, insoluble sulfur, or highly dispersible sulfur can be used. The content of the vulcanizing agent in the rubber composition according to the present invention is preferably 0.1 to 10 parts by mass, more preferably 0.5 to 5 parts by mass when the entire amount of the diene-based rubber is taken as 100 parts by mass.

The nitrogen atom-containing alkaloid compound is mainly present in plants. Examples of the nitrogen atom-containing alkaloid compound usable in the present invention include gramine (melting point: 132° C.), pseudopelletierine (melting point: 46° C.), hordenine (melting point: 118° C.), tetrahydropalmatine (melting point: 150° C.), caffeine (melting point: 238° C.), 3-(3,4-dihydroxyphenyl)-L-alanine (melting point: 278° C.), nicotine (melting point: −80° C.), sparteine (melting point: 31° C.), matrine (melting point: 76° C.), proxyphylline (melting point: 136° C.), cytisine (melting point: 156° C.), bicuculline (melting point: 197° C.), norharman (melting point: 201° C.), cinchonidine (melting point: 206° C.), cordycepin (melting point: 226° C.), tryptanthrin (melting point: 266° C.), and indirubin (melting point: 350° C.). However, when the melting point of the nitrogen atom-containing alkaloid compound is excessively high, the degree of melting in the diene-based rubber may reduce during vulcanization, and in such a case, dispersibility in the diene-based rubber tends to deteriorate. Therefore, the melting point of the nitrogen atom-containing alkaloid compound used in the present invention is preferably 200° C. or lower, more preferably 180° C. or lower. It should be noted that in the present invention, the melting point of the nitrogen atom-containing alkaloid compound is measured by differential scanning calorimetry (DSC) in accordance with JIS K6220.

The content of the nitrogen atom-containing alkaloid compound in the rubber composition according to the present invention is preferably 0.1 to 15 parts by mass, more preferably 0.5 to 10 parts by mass when the entire amount of the diene-based rubber is taken as 100 parts by mass.

The rubber composition according to the present invention is characterized in that sulfur and a nitrogen atom-containing alkaloid compound are used in combination. Setting a mass ratio (A/B) between a content A of the nitrogen atom-containing alkaloid compound and a content B of the sulfur in the rubber composition to 0.2 to 2.0, preferably 0.4 to 1.8 is preferred because the rubber properties of a vulcanized rubber of the rubber composition, such as maximum torque and tensile strength at break, can particularly be improved.

The rubber composition according to the present invention may contain, in addition to the diene-based rubber, the sulfur, and the nitrogen atom-containing alkaloid compound, carbon black, silica, a silane coupling agent, a vulcanizing agent, a vulcanization accelerator, an antiaging agent, stearic acid, a softener such as wax or oil, a processing aid, and others.

Examples of the carbon black that can be used include carbon blacks usually used in the rubber industry, such as SAF, ISAF, HAF, FEF, and GPF; and conductive carbon blacks such as acetylene black and ketjen black. The amount of the carbon black contained in the rubber composition according to the present invention is preferably 5 to 100 parts by mass when the entire amount of a rubber component is taken as 100 parts by mass.

Examples of the silica to be used include silicas usually used for rubber reinforcement, such as wet silica, dry silica, sol-gel silica, and surface-treated silica. Among these, wet silica is preferred.

When silica is contained as a filler, a silane coupling agent is also preferably contained together. The silane coupling agent is not limited as long as sulfur is contained in the molecule thereof, and various silane coupling agents to be added to rubber compositions together with silica may be used. Examples of such silane coupling agents include: sulfidesilanes such as bis(3-triethoxysilylpropyl)tetrasulfide (e.g., “Si69” manufactured by Degussa), bis(3-triethoxysilylpropyl)disulfide (e.g., “Si75” manufactured by Degussa), bis(2-triethoxysilylethyl)tetrasulfide, bis(4-triethoxysilylbutyl)disulfide, bis(3-trimethoxysilylpropyl)tetrasulfide, and bis(2-trimethoxysilylethyl)disulfide; mercaptosilanes such as γ-mercaptopropyltrimethoxysilane, γ-mercaptopropyltriethoxysilane, mercaptopropylmethyldimethoxysilane, mercaptopropyldimethylmethoxysilane, and mercaptoethyltriethoxysilane; and protected mercaptosilanes such as 3-octanoylthio-1-propyltriethoxysilane and 3-propionylthiopropyltrimethoxysilane.

As described above, the nitrogen atom-containing alkaloid compound functions as a vulcanization accelerator that accelerates the cross-linking reaction of sulfur, but the rubber composition according to the present invention may further contain a publicly-known vulcanization accelerator other than the nitrogen atom-containing alkaloid compound. As such a vulcanization accelerator other than the nitrogen atom-containing alkaloid compound, vulcanization accelerators usually used for rubber vulcanization may be used singly or in appropriate combination of two or more of them. Examples of such vulcanization accelerators include sulfenamide-based vulcanization accelerators, thiuram-based vulcanization accelerators, thiazole-based vulcanization accelerators, thiourea-based vulcanization accelerators, guanidine-based vulcanization accelerators, and dithiocarbamate-based vulcanization accelerators.

Examples of the antiaging agent include antiaging agents usually used for rubber, such as an aromatic amine-based antiaging agent, an amine-ketone-based antiaging agent, a monophenol-based antiaging agent, a bisphenol-based antiaging agent, a polyphenol-based antiaging agent, a dithiocarbamic acid salt-based antiaging agent, and a thiourea-based antiaging agent, and these may be used singly or in an appropriate combination of two or more of them.

The rubber composition according to the present invention is obtained by kneading, in addition to the diene-based compound, the sulfur, and the nitrogen atom-containing alkaloid compound, carbon black, silica, a silane coupling agent, a vulcanizing agent, a vulcanization accelerator, zinc oxide, an antiaging agent, stearic acid, a softener such as wax, a processing aid, and others with the use of a kneading machine usually used in the rubber industry, such as a Banbury mixer, a kneader, or a roll.

A method for blending the above components is not limited, and any one of the following methods may be used: a method in which components to be blended other than vulcanization-type compounding agents such as sulfur and a nitrogen atom-containing alkaloid compound are previously kneaded to prepare a master batch, the remaining component is added to the master batch, and the mixture is further kneaded, a method in which components are added in any order and kneaded, and a method in which all the components are added at the same time and kneaded.

A vulcanized rubber of the rubber composition according to the present invention has improved rubber properties such as maximum torque and tensile strength at break. Therefore, a vulcanized rubber of the rubber composition according to the present invention is particularly useful for pneumatic tires.

### EXAMPLES

Hereinbelow, the present invention will more specifically be described with reference to examples.

### Preparation of Rubber Compositions for Tires

A rubber composition for tires of each of Examples 1 to 9 and Comparative Examples 1 to 5 was prepared by blending compounding agents with 100 parts by mass of a rubber component in accordance with a formulation shown in Table 1, 2, or 3 and kneading the resultant using an ordinary Banbury mixer. The compounding agents shown in Tables 1 to 3 are as follows.

### Diene-Based Rubber

Styrene-butadiene rubber (SBR (ESBR (emulsion-polymerized SBR))): trade name “SBR1502” (manufactured by ENEOS Materials Corporation)
Natural rubber (NR): RSS#3

### Sulfur

Trade name “Powder Sulfur” (manufactured by Tsurumi Chemical Industry Co., ltd.)

### Nitrogen Atom-Containing Alkaloid Compound

Gramine (melting point: 132° C.): (manufactured by Tokyo Chemical Industry Co., Ltd.)
Pseudopelletierine (melting point: 46° C.): (manufactured by Tokyo Chemical Industry Co., Ltd.)
Hordenine (melting point: 118° C.): (manufactured by Tokyo Chemical Industry Co., Ltd.)
Tetrahydropalmatine (melting point: 150° C.): (manufactured by Tokyo Chemical Industry Co., Ltd.)
Caffeine (melting point: 238° C.): (manufactured by Tokyo Chemical Industry Co., Ltd.)
3-(3, 4-Dihydroxyphenyl)-L-alanine (melting point: 278° C.): (manufactured by Tokyo Chemical Industry Co., Ltd.)

### Other Compounding Agents

Carbon black; trade name “Showa Black N330T” (manufactured by Cabot Japan)
Zinc oxide: trade name “Zinc Oxide Grade 3” (manufactured by MITSUI MINING & SMELTING CO., LTD.)
Stearic acid: trade name “LUNAC S-20” (manufactured by Kao Corporation)
Vulcanization accelerator CZ: trade name “NOCCELER CZ-G” (manufactured by OUCHI SHINKO CHEMICAL INDUSTRIAL CO., LTD.)

The rubber compositions of Examples 1 to 9 and Comparative Examples 1 to 5 were vulcanized at 160° C. by applying pressure using a metallic plate as a mold to prepare vulcanized rubber samples. As a vulcanization time, 90% vulcanization time (t90) (measurement result at 160° C. for 60 minutes) specified in JIS K6300-2 was used.

### <Vulcanization Characteristics (Maximum Torque) of Rubber Composition>

A test based on JIS K6300-2 was performed. The measurement was performed at 160° C. for 60 minutes to determine a maximum torque. In the case of Examples 1 to 7, the maximum torques were expressed as index numbers determined when the maximum torque of Comparative Example 1 was taken as 100, in the case of Example 8, the maximum torque was expressed as an index number determined when the maximum torque of Comparative Example 4 was taken as 100, and in the case of Example 9, the maximum torque was expressed as an index number determined when the maximum torque of Comparative Example 5 was taken as 100. A larger index number indicates that the rubber composition is more excellent in vulcanization characteristics (maximum torque).

### <Tensile Test (Tensile Strength at Break of Vulcanized Rubber) >

A test based on JIS 6251 was performed. A No. 7 dumbbell test specimen was used. In the case of Examples 1 to 7, the tensile strengths at break were expressed as index numbers determined when the tensile strength at break of Comparative Example 1 was taken as 100, in the case of Example 8, the tensile strength at break was expressed as an index number determined when the tensile strength at break of Comparative Example 4 was taken as 100, and in the case of Example 9, the tensile strength at break was expressed as an index number determined when the tensile strength at break of Comparative Example 5 was taken as 100. A larger index number indicates that a vulcanized rubber of the rubber composition is more excellent in tensile strength at break.

TABLE 1

| | | Comparative | Comparative | Example | Example | Example | Example | Example | Example | Example |
|---|---|---|---|---|---|---|---|---|---|---|
| | | Example 1 | Example 2 | 1 | 2 | 3 | 4 | 5 | 6 | 7 |
| Styrene-butadiene rubber | | | 100 | 100 | 100 | 100 | 100 | 100 | 100 | 100 |
| Natural rubber | | | | | | | | | | |
| Carbon black | | | 50 | 50 | 50 | 50 | 50 | 50 | 50 | 50 |
| Zinc oxide | | | 2 | 2 | 2 | 2 | 2 | 2 | 2 | 2 |
| Stearic acid | | | 2 | 2 | 2 | 2 | 2 | 2 | 2 | 2 |
| Sulfur | | | 2 | 2 | 2 | 2 | 2 | 2 | 2 | 2 |
| Nitrogen | Caffeine | 1.1 | | | | | | | | |
| atom- | 3-(3,4-Dihydroxy- | | 1.1 | | | | | | | |
| containing | phenyl)-L-alanine | | | | | | | | | |
| alkaloid | Gramine | | | 1 | 2 | 3 | 1 | | | |
| compound | Pseudopelletierine | | | | | | | 0.9 | | |
| | Hordenine | | | | | | | | 0.9 | |
| | Tetrahydropalmatine | | | | | | | | | 2 |

| | | | | | | | | | |
|---|---|---|---|---|---|---|---|---|---|
| Vulcanization accelerator CZ | | | | | | 0.75 | | | |
| Maximum torque | 100 | 93 | 185 | 211 | 219 | 267 | 120 | 178 | 243 |
| Tensile strength at break | 100 | 80 | 219 | 253 | 265 | 267 | 137 | 242 | 273 |

The blend systems shown in Table 1 are systems containing 100 parts by mass of a styrene-butadiene rubber as a rubber component. As can be seen from the results shown in Table 1, the rubber compositions of Examples 1 to 7 are excellent in vulcanization characteristics (maximum torque) and vulcanized rubbers of the rubber compositions are excellent in tensile strength at break.

TABLE 2

| | | Comparative | Example |
|---|---|---|---|
| | | Example 4 | 8 |
| Styrene-butadiene rubber | | | |
| Natural rubber | | 100 | 100 |
| Carbon black | | 50 | 50 |
| Zinc oxide | | 2 | 2 |
| Stearic acid | | 2 | 2 |
| Sulfur | | 2 | 2 |
| Nitrogen | Caffeine | 1.1 | |
| atom- | 3-(3,4-Dihydroxyphenyl)-L-alanine | | |
| containing | Gramine | | 1 |
| alkaloid | Pseudopelletierine | | |
| compound | Hordenine | | |
| | Tetrahydropalmatine | | |

| | | |
|---|---|---|
| Vulcanization accelerator CZ | | |
| Maximum torque | 100 | 180 |
| Tensile strength at break | 100 | 152 |

The blend systems shown in Table 2 are systems containing 100 parts by mass of a natural rubber as a rubber component. As can be seen from the results shown in Table 2, the rubber composition of Example 8 is excellent in vulcanization characteristics (maximum torque) and a vulcanized rubber of the rubber composition is excellent in tensile strength at break.

TABLE 3

| | | Comparative | Example |
|---|---|---|---|
| | | Example 5 | 9 |
| Styrene-butadiene rubber | | 50 | 50 |
| Natural rubber | | 50 | 50 |
| Carbon black | | 50 | 50 |
| Zinc oxide | | 2 | 2 |
| Stearic acid | | 2 | 2 |
| Sulfur | | 2 | 2 |
| Nitrogen | Caffeine | 1.1 | |
| atom- | 3-(3,4-Dihydroxyphenyl)-L-alanine | | |
| containing | Gramine | | 1 |
| alkaloid | Pseudopelletierine | | |
| compound | Hordenine | | |
| | Tetrahydropalmatine | | |

| | | |
|---|---|---|
| Vulcanization accelerator CZ | | |
| Maximum torque | 100 | 163 |
| Tensile strength at break | 100 | 170 |

The blend systems shown in Table 3 are systems containing 50 parts by mass of a styrene-butadiene rubber and 50 parts by mass of a natural rubber as a rubber component. As can be seen from the results shown in Table 3, the rubber composition of Example 9 is excellent in vulcanization characteristics (maximum torque) and a vulcanized rubber of the rubber composition is excellent in tensile strength at break.

What is claimed is:

1. A rubber composition containing a diene-based rubber, sulfur, and a nitrogen atom-containing alkaloid compound having a melting point of 200° C. or lower.

2. The rubber composition according to claim 1, wherein the nitrogen atom-containing alkaloid compound has a tertiary amine structure.

3. The rubber composition according to claim 1, wherein a mass ratio (A/B) between a content A of the nitrogen atom-containing alkaloid compound and a content B of the sulfur in the rubber composition is 0.2 to 2.0.

4. The rubber composition according to claim 1, wherein the nitrogen atom-containing alkaloid compound is at least one selected from the group consisting of gramine, pseudopelletierine, hordenine, and tetrahydropalmatine.

5. A pneumatic tire comprising at least a vulcanized rubber of the rubber composition according to claim 1.
